(19) United States
(12) Patent Application Publication
(10) Pub. No.: US 2002/0147025 A1
(43) Pub. Date: Oct. 10, 2002

(54) Systems and methods for base station signal transmission power control

(75) Inventor: Alpaslan Gence Savas, San Diego, CA (US)

Correspondence Address: David E. Bennett, Coats & Bennett, P.L.L.C., 1400 Crescent Green, Suite 300, Cary, NC, 27511, US

(73) Assignee: Telefonaktiebolaget LM Ericsson

(21) Appl. No.: 09/828,362

(22) Filed: Apr. 5, 2001

(51) Int. Cl. H04B 7/00

(52) U.S. Cl. 455/522; 455/511; 455/561

(57) ABSTRACT

A power control system for controlling the transmission power of a Base Station (BS) transmitter in a wireless radio network is provided. The BS transmitter transmits a signal to a Mobile Station (MS) in the wireless radio network, wherein the signal is divided into frames, each frame being further divided into Link Transmission Units (LTUs). In an exemplary embodiment the wireless radio network may be a CDMA cellular communication system. The power control systems measures the Frame Error Rate (FER) and the Eb/Nt (energy per bit to total noise density) of the signal received by the MS. In addition, the power control system measures the number of LTU errors in a frame of the signal received by the MS. The power control system then transmits a power control command from the MS to the BS transmitter based on the measured FER, number of LTU errors and Eb/Nt, instructing the BS transmitter to either increase or decrease its transmission power by a certain amount.

### FIELD OF THE INVENTION

The present invention relates generally to a wireless radio network and, more particularly, to systems and methods for controlling the power of a Base Station (BS) transmitter in the wireless radio network.

### BACKGROUND OF THE INVENTION

In a wireless radio network, a Base Station (BS) communicates with a Mobile Station (MS), e.g., a cellular phone. One exemplary wireless radio network is a Code Vidision Multiple Access (CDMA) cellular communications system. In a forward direction (downlink) of the CDMA system, the BS transmits a signal, which is divided into 20 ms frames, to the MS over a forward traffic channel. Typically, the CDMA network employs a power control system to control the transmission power of the BS transmitter in order to maintain a desired Frame Error Rate (FER) of the received signal at the MS.

A typical power control system comprises an outer loop power control and an inner loop power control, both of which are located in the MS. The outer loop power control compares an estimation of the FER of the received signal with a target FER, typically one percent. The outer loop power control then adjusts an Eb/Nt (energy per bit to total noise density) set point based on this comparison, where Eb/Nt is a measure of the quality of the received signal. If the estimated FER is greater than the target FER, then the outer loop power control increases the Eb/Nt set point by a certain amount. Otherwise, the outer loop power control decreases the Eb/Nt set point by a certain amount.

The inner loop power control receives the Eb/Nt set point from the outer loop power control. The inner loop power control compares the Eb/Nt set point with an estimation of the Eb/Nt of the received signal. The inner loop power control then outputs a power control command based on this comparison. If the estimated Eb/Nt is less than the Eb/Nt set point, then the inner loop power control outputs a power control command instructing the BS transmitter to increase its transmission power. Otherwise, the inner loop power control outputs a power control command instructing the BS transmitter to decrease its transmission power.

The MS transmits the power control command to the BS over a reverse (uplink) channel. The BS transmitter then increases or decreases its transmission power by a certain amount, e.g., 1 dB, based on the received power control command from the MS.

A drawback of this power control system is that the outer loop power loop typically increases the Eb/Nt set point by a constant amount when the estimated FER is greater than the target FER, regardless of the number of bit errors within each frame of the received signal. This is because the estimated FER only provides information about the number of frames that are received in error by the MS and not the number bit errors within each received frame.

Therefore, there is a need for a power control system comprising an outer loop power control that is able to make fine adjustments to the Eb/Nt set point based on additional information about the received frames. This would provide higher performance and accuracy in adjusting the Eb/Nt set point to achieve a desired FER of the received signal at the MS.

### SUMMARY OF THE INVENTION

The present invention addresses the aforementioned problems by providing a power control system comprising an outer loop power control that is able to make fine adjustments to the Eb/Nt set point based on additional information about the frames received by the MS.

In one embodiment of the present invention, the BS transmitter transmits a signal to the MS over a forward traffic channel. The signal is divided into frames, and each frame is further divided into Logical Transmission Units (LTU). Each LTU comprises an LTU Cyclic Read Check (CRC) field that enables the MS to individually detect an error in each LTU of a received frame. The MS comprises an MS receiver, an FER estimator, an outer loop power control, an inner loop power control and an MS transmitter. The MS receiver demodulates and decodes the signal from the BS. The MS receiver also calculates the number of LTU errors in a currently received frame of the received signal by checking the LTU CRC field in each LTU of the currently received frame. The FER estimator estimates a FER of the decoded signal from the MS receiver and outputs an estimated FER.

The outer loop control receives the estimated FER from the FER estimator and the number of LTU errors in the currently received frame from the MS receiver. The outer loop power control then compares the estimated FER from the FER estimator with a target FER, e.g., one percent. If the estimated FER is greater than the target FER, then the outer loop power control increases the Eb/Nt set point by an up step value that is a function of the number of LTU errors received from the MS receiver. Otherwise, the outer loop power control decreases the Eb/Nt set point by a down step value. In one variation of the invention, the down step value may be varied according to the number of LTU errors.

The inner loop power control receives the Eb/Nt set point from the outer loop power control and an estimated Eb/Nt of the received signal from the MS receiver. The inner loop power control then compares the Eb/Nt set point with the estimated Eb/Nt from the MS receiver. If the estimated Eb/Nt is less than the Eb/Nt set point, then the inner loop power control outputs a power control command instructing the BS transmitter to increase its transmission power. Otherwise, the inner loop power control outputs a power control command instructing the BS transmitter to decrease its transmission power. The MS transmitter then transmits the power control command to the BS over a reverse pilot channel.

An advantage of the outer loop power control according to the present invention is that it is able to make finer adjustments to the Eb/Nt set point compared with the prior art. This is because the outer loop power control of the prior art increases the Eb/Nt set point by a constant amount when the estimated FER is greater than the target FER, regardless of the number of bit errors within each frame of the received signal. The outer loop power control according to the present invention, on the other hand, varies the amount that the Eb/Nt set point is increased based on the number of LTU errors of a currently received frame of the received signal. This results in a greater range in the magnitude of adjustments possible for fine accuracy in the adjustment of the Eb/Nt set point.

In another embodiment of the invention, the FER estimator is replaced with an LTU error rate estimator. The LTU error rate estimator estimates an LTU error rate of the received signal by checking the LTU CRC fields in the received signal. The outer loop receives the estimated LTU error rate from the LTU error rate estimator and a target LTU error rate. The outer loop power control then adjusts the Eb/Nt set point based on a comparison of the estimated LTU error rate with the target LTU error rate. If the estimated LTU error rate is greater than the target LTU error rate, then the outer loop power control increases the Eb/Nt set point by a certain amount. Otherwise, the outer loop power control decreases the Eb/Nt set point by a certain amount.

Other objects and features of the present invention will become apparent from consideration of the following description taken in conjunction with the accompanying drawings.

### BRIEF DESCRIPTION OF THE DRAWINGS

The drawings illustrate both the design and utility of the preferred embodiments of the present invention, in which similar elements in different embodiments are referred to by the same reference numbers for purposes of ease in illustration of the invention, wherein:

FIG. 1 is a block diagram of an exemplary power control system according to an embodiment of the present invention.

FIG. 2 is a diagram of a frame structure according to an embodiment of the present invention.

FIG. 3 is a block diagram of an exemplary power control system according to another embodiment of the present invention.

### DETAILED DESCRIPTION OF THE PREFERED EMBODIMENTS

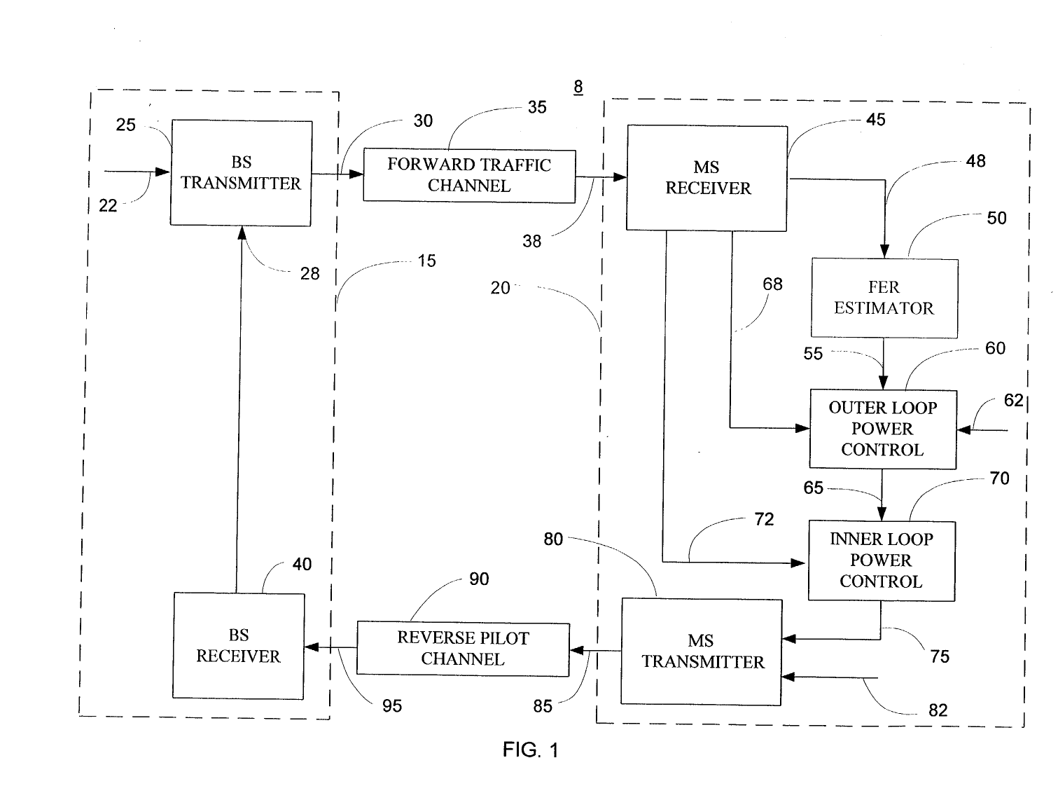

FIG. 1 shows an exemplary power control system 8 according to an embodiment of the present invention. The power control system 8 comprises a Base Station BS 15 and a Mobile Station (MS) 20, e.g., a cellular phone. The BS 15 further comprises a BS transmitter 25 having a power control input 28 and a BS receiver 40 coupled to the power control input 28 of the BS transmitter 25. The MS 20 further comprises an MS receiver 45, a frame error rate (FER) estimator 50 coupled to the MS receiver 45 and an outer loop power control 60 coupled to an output 55 of the FER estimator 50. The MS 20 also comprises an inner loop power 70 control coupled to an output 65 of the outer loop power control 60 and an MS transmitter 80 coupled to an output 75 of the inner control power loop 70.

During operation, the BS transmitter 25 modulates an incoming signal 22 into a spread-spectrum signal 30 using a spreading code. The BS transmitter 25 then transmits the spread-spectrum signal 30 using a forward traffic channel 35 to the MS 20. Preferably, the forward traffic channel 35 comprises at least one Supplemental Channel (SCH) that carries non-voice data to the MS 20. The non-voice data may be used for providing fax and Internet applications to the MS 20. The forward traffic channel 35 may also comprise a fundamental channel (FCH) that carries voice data to the MS 20.

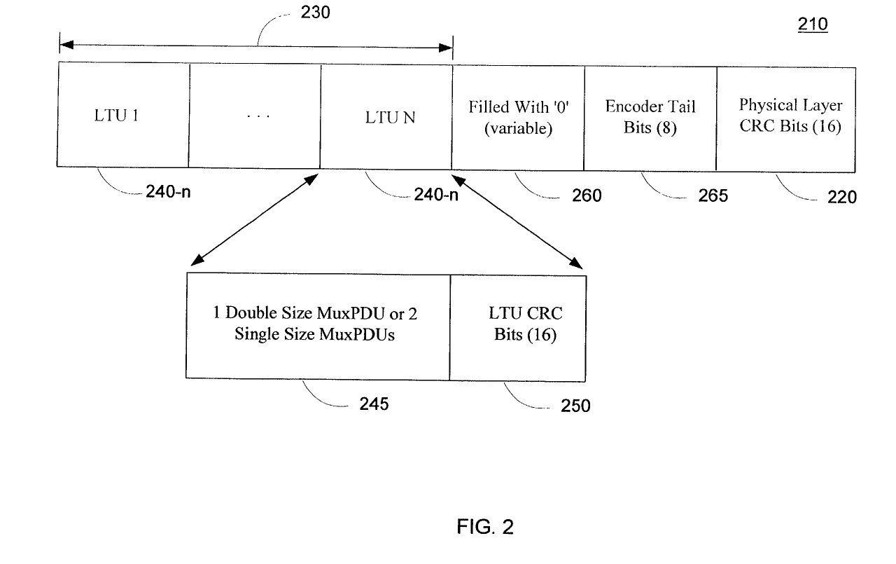

The present invention preferably uses an SCH according to the IS-2000 standard established by the Telecommunications Industry Association (TIA). The SCH according to the IS-2000 standard is divided into 20 ms SCH frames. FIG. 2 shows an exemplary SCH frame structure according to the IS-2000 standard. The SCH frame 210 comprises a physical layer Cylic Read Check (CRC) 220, which is typically 16 bits in length. The physical layer CRC 220 enables the MS 20 to detect a frame error of a received SCH frame 210 by inputting the physical layer CRC 220 into a state machine that outputs all ‘0’s when the SCH frame 210 is correctly received.

The SCH frame 210 further comprises an information data field 230 containing Multiplex layer Protocol Data Units (MuxPDU). The information data field 230 is divided into Link Transmission Units (LTUs) 240-n. The information data field 230 may be divided into 2, 4 or 8 LTUs 240-n. Each LTU 240-n contains one or more MuxPDUs, depending on the chosen multiplex option provided by the IS-2000 standard. In FIG. 2, each LTU 240-n may contain either a 1 double size MuxPDU or 2 single size MuxPDUs 245. Each LTU 240-n further includes a LTU CRC field 250, which is 16 bits in length. The LTU CRC field 250 in each LTU 240-n enables the MS 20 to individually detect an error in each LTU 240-n of a received SCH frame 210. The SCH frame 210 may also comprise a field 260 containing a variable number of ‘0’s and an encoder tail field 265, which is 8 bits in length.

At the MS 20, the MS receiver 45 demodulates the received spread-spectrum signal 38 by despreading the spread-spectrum signal 38. The MS receiver 45 then decodes the demodulated signal and outputs the decoded signal 48 to the FER estimator 50. The FER estimator 50 estimates a Frame Error Rate (FER) of the decoded signal 48, where the FER represents the percentage of frames of the decoded signal 48 that are received in error by the MS 20. To estimate the FER, the FER estimator 50 detects the number of frame errors of the decoded signal 48 within a time period by checking the physical layer CRC 250 of each frame within the time period. The FER estimator 50 may then employ any one or a combination of well known techniques in the art for estimating a FER based on the number of detected frame errors of a decoded signal.

The outer loop power control 60 receives the estimated FER 55 from the FER estimator 50 at a rate of about one estimated FER per frame of the decoded signal 48. The outer loop power control 60 also receives a target FER 62, e.g., one percent. In addition, the outer loop power control 60 receives a number of LTU errors 68, denoted N_{E}, in a currently received frame of the decoded signal 48 from the MS receiver 45. The MS receiver 45 calculates the number of LTU errors, NE, in the currently received frame by checking the LTU CRC field 240-n of each LTU in the currently received frame.

The outer loop power control 60 uses the estimated FER 55, the target FER 62 and the number of LTU errors 68, N_{E}, in the currently received frame to adjust an Eb/Nt (energy per bit to total noise density) set point, where Eb/Nt is a measure of the quality of the received signal 38. To adjust the current Eb/Nt set point, Eb/Nt_{CURR}, the outer loop power control 60 compares the currently received estimated FER 55 from the FER estimator 50 with the target FER 62.

If the estimated FER 55 is higher than the target FER 62, then the outer loop power control 60 increases the previous Eb/Nt set point, Eb/Nt_{PREV}, according to the formula:

Eb/Nt_{CURR}=Eb/Nt_{PREV}+Δ_{UP}(N_{E})

where Eb/Nt_{PREV} is increased by an up step value of Δ_{UP}(N_{E}), the magnitude of which is a function of the number of LTU errors 68, N_{E}, from the MS receiver 45. The up step value Δ_{UP}(N_{E}) for each possible number of LTU errors, N_{E}, may be provided to the outer loop power control 60 by a lookup table that assigns an up step value to each possible N_{E}. Preferably, the magnitude of the up step value Δ_{UP}(N_{E}) increases for increasing N_{E}. This is because an increasing N_{E} is usually caused by worsening channel conditions between the BS 15 and the MS 20 in the forward direction.

If the estimated FER 55 is less than the target FER 62, then the outer loop power control 60 decreases the previous Eb/Nt set point, Eb/Nt_{PREV}, according to the formula:

Eb/Nt_{CURR}=Eb/Nt_{PREV}−Δ_{DOWN}

where Eb/Nt_{PREV} is decreased by a down step value of Δ_{Down}.

The outer loop power control 60 adjusts the Eb/Nt set point each time it receives an estimated FER 55 from the FER estimator 50, which occurs once per frame of the decoded signal. As a result, the outer loop power control 60 provides frame-by-frame adjustment of the Eb/Nt set point.

The inner loop power control receives 70 the Eb/Nt set point 65 from the outer loop power control 60 at a rate of about once per frame. In addition, the inner loop power control 70 receives an estimated Eb/Nt 72 of the received signal 38 from the MS receiver 45. The MS receiver 45 outputs the estimated Eb/Nt 72 to the inner loop power control 70 at a rate greater than once per frame, preferably 16 times per frame. The inner loop power control 70 compares the received Eb/Nt set point 65 with the estimated Eb/Nt 72 from the MS receiver 45. The inner loop power control 70 then outputs a power control command 75 based on the comparison. If the estimated Eb/Nt is less than the Eb/Nt set point, then the inner loop power control 70 outputs a power control command 75 instructing the BS 15 to increase its transmission power. Otherwise, the inner loop power control 70 outputs a power control command 75 instructing the BS 15 to decrease its transmission power. The power command may be one bit in length in which a bit value of one instructs the BS 15 to increase its transmission power and a bit value of zero instructs the BS 15 to decrease its transmission power. The inner loop power control 70 outputs a power control command 75 each time that it receives an estimated Eb/Nt 72 from the MS receiver 45. Preferably, the inner loop power control 70 outputs a power control command 70 at a rate of about 16 times per frame. For a frame length of about 20 ms, the inner loop power control 70 outputs a power control command 75 every 1.25 ms.

The MS transmitter 80 receives power control commands 75 from the inner loop power control 70 and a pilot signal 82, which may be a pseudo random sequence. The pilot signal 82 is divided into 20 ms frames. Each frame of the pilot signal is further divided into 16 power control groups (PCGs) with each PCG having a length of 1.25 ms. The MS transmitter 80 multiplexes the power control commands 75 with the pilot signal 82 so that one power control command is placed into each PCG of the pilot signal 82. The MS transmitter 80 then transmits the pilot signal 85 multiplexed with the power control commands to the BS 15 using a reverse pilot channel 90.

The BS receiver 40 demodulates and decodes the received pilot signal 90 from the MS 20, and extracts the power control commands from the pilot signal 90. The extracted power control commands are sent to the power control input 28 of the BS transmitter 25. The BS transmitter 25 then adjusts its transmission power level by a predetermined amount, e.g., 1 dB, based on the received power control commands. The BS transmitter 25 may adjust its transmission power level by adjusting the power level of a power amplifier (not shown) in the BS transmitter 25.

An advantage of the power control system 8 of the present invention is that the outer loop power control 60 is able to make finer adjustments to the Eb/Nt set point compared with the prior art. This is because the power control system of the prior art increases the Eb/Nt set point by a constant amount when the estimated FER is greater than the target FER, regardless of the number of bit errors within each received frame. The power control system 8 of the present invention, on the other hand, varies the amount that the Eb/Nt set point is increased based on the number of LTU errors in a currently received frame. This result in greater granularity in the adjustment of the Eb/Nt set point so as to improve the sensitivity of base station power adjustments. In addition, the number of LTU errors in the currently received frame provides the outer loop power control 70 with greater resolution in assessing the channel conditions between the BS 15 and the MS 20 than the case where only the estimated FER is used.

The up step value Δ_{UP}(N_{E}) for each possible number of LTU errors, N_{E}, in a received frame may be found experimentally or through a computer simulation. This may be done, for example, by adjusting the up step value Δ_{UP}(N_{E}) for each number of LTU errors, N_{E}, to a value that minimizes both a measured FER and a measured Eb/Nt. This may help to further optimize the forward link channel capacity and the power efficiency of the BS 15.

In another embodiment of the invention, the outer loop power control 60 also varies the down step value Δ_{DOWN} as a function of the number of LTU errors 68 from the MS receiver 45. In this embodiment, when the estimated FER 55 is less than the target FER 62, the outer loop adjusts the current Eb/Nt set point, Eb/Nt_{CURR}, according to the formula:

Eb/Nt_{CURR}=Eb/Nt_{PREV}−Δ_{DOWN}(N_{E})

where the down step value Δ_{DOWN}(N_{E}) is now a function of the number of LTU errors, N_{E}, of the currently received frame. Preferably, the magnitude of the down step value Δ_{DOWN}(N_{E}) decreases with increasing N_{E}. The down step value Δ_{DOWN}(N_{E}) for each possible N_{E} may be found by employing methods similar to those used to find the up step value Δ_{UP}(N_{E}) for each possible N_{E}.

Even though the outer loop power control 60 adjusts the Eb/Nt set point once per frame, preferably, the outer loop power control 60 does not increase the Eb/Nt set point twice when two consecutive estimated FERs 55 from the FER estimator 50 are greater than target FER 62. This is because there is typically a time delay before a power control command based on an Eb/Nt set point is received by the BS transmitter 15. Because of this time delay, the outer loop power control 70 can not immediately determine if an increase in the Eb/Nt set point is sufficient to reduce the estimated FER 55 below the target FER 62 or if an additional increase in the Eb/Nt set point is necessary. Thus, in a preferred embodiment, the outer loop power control 70 waits for a time period of about 3 to 4 frames after increasing the EB/Nt set point before increasing the Eb/Nt set point again, even when the estimated FER 55 is greater than the target FER 62 within the time period. The time period is chosen to give the outer loop control power 60 enough time to determine the effect of an increase in the Eb/Nt set point on the estimated FER 55. Within this time period, the outer loop control 70 decreases the Eb/Nt by the step value Δ_{DOWN} for each frame.

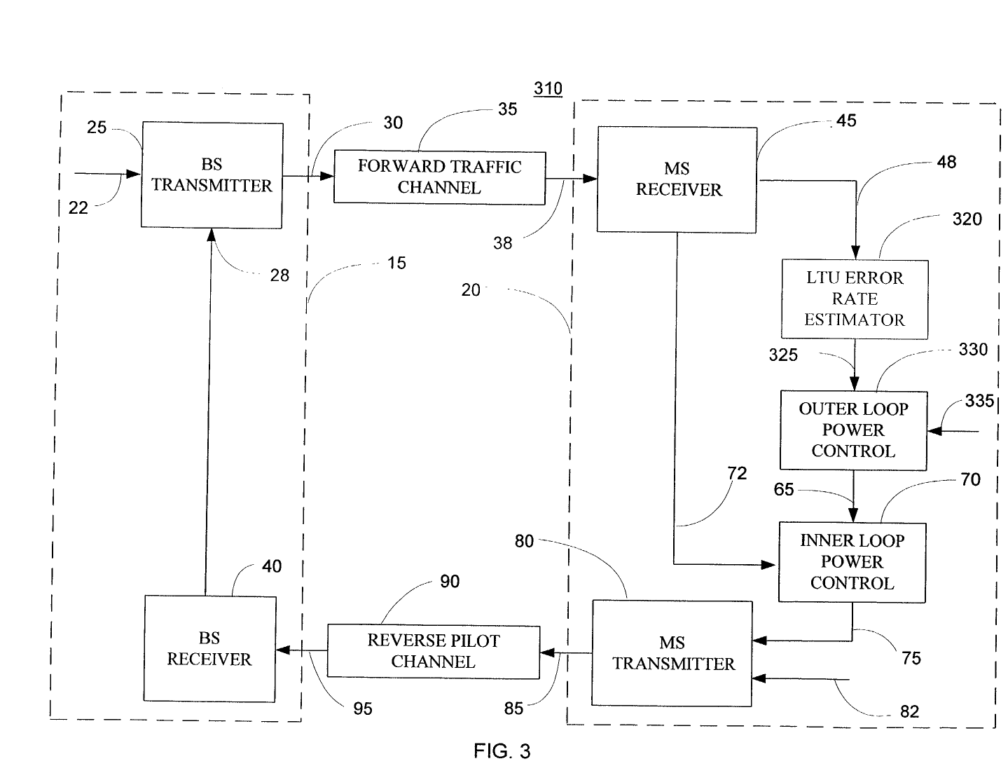

FIG. 3 shows a power control system 310 according to another embodiment of the invention. In this embodiment, a LTU error rate estimator 320 replaces the FER estimator 50 of FIG. 1. The LTU error rate estimator 320 estimates a LTU error rate for the decoded signal 48, i.e. the percentage of LTUs in the decoded signal 48 that are received in error by the MS 20. The LTU error rate estimator 320 estimates the LTU error rate by checking the LTU CRC fields in the LTUs of the decoded signal 48.

The outer loop power control 330 receives the estimated LTU error rate 325 from the LTU error rate estimator 320, preferably once per frame. The outer loop power control 330 also receives a target LTU error rate 335. The outer loop power control 330 then compares the estimated LTU error rate 325 with the target LTU error rate 335. If the estimated LTU error rate is greater than the target LTU error rate 335, then the outer loop power control 330 increases the Eb/Nt set point 65 by a step value of Δ_{UP}. Otherwise, the outer loop power control 330 decreases the Eb/Nt set point 65 by a step value of Δ_{DOWN}. In this embodiment, the outer loop power loop 330 does not vary the up step value Δ_{UP} based on the number of LTU errors in a received frame. This is because information based on LTU errors in the decoded signal 48 is already incorporated into the estimated LTU error rate 325 from the LTU error rate estimator 320. Thus, the power control system 310 according to this embodiment adjusts the transmission power of the BS 15 transmitter to achieve a desired LTU error rate at the MS 20.

While various embodiments of the application have been described, it will be apparent to those of ordinary skill in the art that many more embodiments and implementations are possible that are within the scope of the present invention.

For example, even though Eb/Nt was used as a measure of the quality of the received signal, those skilled in the art will appreciate that another quantity measure may be used by the outer loop power control 60 for the same purpose. For example, many BS transmitters use an orthogonal Walsh code to modulate an incoming signal. In this case, the outer loop power control loop 60 may adjust an Ew/Nt (Energy per Walsh code to total noise density) set point instead of an Eb/Nt set point. The outer loop power control 60 may also receive an estimated Ew/Nt of the received signal 38 from the MS receiver instead of an estimated Eb/Nt. In addition, the MS receiver 20 may output an average of the number of LTU errors per received frame instead of outputting the number of LTU errors in the currently received frame. Further, the MS is not limited to a cellular telephone but may be one or more of any number of wireless devices including a personal digital assistant (PDA), web pad, laptop personal computer (PC), etc. Therefore, the invention is not to be restricted or limited except in accordance with the following claims and their equivalents.

What is claimed is:

1. A method for controlling power of a Base Station (BS) transmission signal, comprising:
adjusting a Frame Error Rate (FER) using a measure of Link Transmission Unit (LTU) errors.

2. The method of claim 1, wherein the signal is divided into frames, each frame being further divided into at least two LTUs, the method further comprising
receiving the signal at a Mobile Station (MS);
estimating the FER of the received signal;
calculating a number of LTU errors in a frame of the received signal; and
receiving a target FER at the MS, wherein the received signal FER is adjusted by
increasing a set point by an up step value when the estimated FER is greater than the received target FER, wherein the magnitude of the up step value depends on the calculated number of LTU errors; and
decreasing the step point by a down step value when the estimated FER is less than the target FER.

3. The method of claim 2, wherein the set point is a energy-per-bit-to-total-noise-density (Eb/Nt) set point.

4. The method of claim 3, further comprising
estimating the Eb/Nt of the received signal;
transmitting a power control command from the MS to the BS transmitter instructing the BS transmitter to increase its transmission power when the estimated Eb/Nt is less than the Eb/Nt set point; and
transmitting a power control command from the MS to the BS transmitter instructing the BS transmitter to decrease its transmission power when the estimated Eb/Nt is greater than the Eb/Nt set point.

5. The method of claim 2, wherein the set point is a energy-per-Walsh-code-to-total-noise-density (Ew/Nt) set point.

6. The method of claim 2, wherein each LTU comprises an LTU Cyclic Read Check (CRC) field and wherein calculating the number of LTU errors in a frame further comprises checking the LTU CRC field of each LTU in the frame.

7. The method of claim 2, wherein the magnitude of the up step value is provided by a lookup table that assigns an up step value for each possible number of LTU errors in a frame.

8. The method of claim 1, wherein the target FER is approximately one percent.

9. The method of claim 1, wherein the BS operates using Code Division Multiple Access (CDMA).

10. A method for controlling power of a Base Station (BS) transmission signal, comprising:
adjusting the signal power using a measure of Link Transmission Unit (LTU) error rate.

11. The method of claim 10, wherein the signal is divided into frames, each frame being further divided into at least two Link Transmission Units (LTUs), and wherein the signal power is adjusted by
receiving the signal at a mobile station (MS);
estimating the LTU error rate of the received signal;
receiving a target LTU error rate at the MS;
increasing a set point by an up step value when the estimated LTU error rate is greater than the target LTU error rate; and
decreasing the step point by a down step value when the estimated LTU error rate is less than the target LTU error rate.

12. The method of claim 11, wherein the set point is a energy-per-bit-to-total-noise-density (Eb/Nt) set point.

13. The method of claim 12, further comprising:
estimating the Eb/Nt of the received signal;
transmitting a power control command from the MS to the BS transmitter instructing the BS transmitter to increase its transmission power when the estimated Eb/Nt is less than the Eb/Nt set point; and
transmitting a power control command from the MS to the BS transmitter instructing the BS transmitter to decrease its transmission power when the estimated Eb/Nt is greater than the Eb/Nt set point.

14. The method of claim 11, wherein the set point is a energy-per-Walsh-code-to-total-noise-density (Ew/Nt) set point.

15. The method of claim 11, wherein each LTU comprises an LTU Cyclic Read Check (CRC) field and wherein estimating the LTU error rate further comprises checking the LTU CRC fields of the received signal.

16. A mobile station (MS), comprising:
a base station power control module that adjusts a base station signal power using a measure of Link Transmission Unit (LTU) errors.

17. The MS of claim 16, wherein the signal is divided into frames, each frame being further divided into at least two Link Transmission Units (LTUs), the MS further comprising
an receiver configured for receiving the signal from a base station (BS) transmitter and outputting a decoded signal of the received signal and a number of LTU errors in a frame of the received signal;
a Frame Error Rate (FER) estimator coupled to the MS receiver, the FER estimator configured for estimating an FER of the decoded signal from the MS receiver and outputting the estimated FER of the decoded signal; and
an outer loop power control coupled to the FER estimator, the outer loop power control configured for receiving the estimated FER from the FER estimator and the number of LTU errors from the MS receiver and a target FER, and for adjusting and outputting a set point, wherein the outer loop power control increases the set point by an up step value when the estimated FER is greater than the target FER, the magnitude of the up set value depending upon the number of LTU errors, and decreases the set point by a down set value when the estimated FER is less than the target FER.

18. The MS of claim 17, wherein the MS receiver outputs an estimated energy-per-bit-to-total-noise-density (Eb/Nt) of the received signal and the set point is an Eb/Nt set point, the MS further comprising
an inner loop power control for receiving the Eb/Nt set point from the outer loop power control and the estimated Eb/Nt from the MS receiver and outputting a power control command, wherein the power control command instructs the BS transmitter to increase its transmission power when the estimated Eb/Nt is less than the Eb/Nt set point and the power control command instructs the BS transmitter to decrease its transmission power when the estimated Eb/Nt is greater than the Eb/Nt set point; and
an MS transmitter for receiving the power control command from the inner loop power control and transmitting the power control command to a BS comprising the BS transmitter.

19. The MS of claim 17, wherein the magnitude of the up step value is provided to the outer loop power control by a lookup table that assigns an up step value for each possible number of LTU errors of a frame of the received signal.

20. The MS of claim 17, wherein the set point is a energy-per-Walsh-code-to-total-noise-density (Ew/Nt) set point.

21. The MS of claim 17, wherein each LTU comprises an LTU Cyclic Read Check (CRC) field and the MS receiver estimates the number of LTU errors in a frame by checking the LTU CRC fields in the frame.

22. The MS of claim 18, wherein the MS transmitter receives a pilot signal, multiplexes the received power control command with the received pilot signal, and outputs the multiplexed pilot signal to the BS comprising the BS transmitter.

23. The MS of claim 16, wherein the signal is divided into frames, each frame being further divided into at least two Link Transmission Units (LTUs), the MS further comprising
an MS receiver receiving the signal from the BS transmitter and outputting a decoded signal of the received signal;
an LTU error rate estimator coupled to the receiver, the LTU error rate estimator estimating an LTU error rate of the decoded signal from the MS receiver and outputting the estimated LTU error rate of the decoded signal; and
an outer loop power control coupled to the receiver, the LTU error rate estimator receiving the estimated LTU error rate from the LTU error rate estimator and a target LTU error rate and adjusting and outputting a set point, wherein the outer loop power control increases the set point by an up step value when the estimated LTU error rate is greater than the target LTU error rate and the outer loop power control decreases the set point by a down set value when the estimated LTU error rate is less than the target LTU error rate.

24. The MS of claim 23, wherein the MS receiver outputs an estimated energy-per-bit-to-total-noise-density (Eb/Nt) of the received signal and the set point is an Eb/Nt set point, the MS further comprising:
an inner loop power control for receiving the Eb/Nt set point from the outer loop power control and the estimated Eb/Nt from the MS receiver, and outputting a power control command, wherein the power control command instructs the BS transmitter to increase its transmission power when the estimated Eb/Nt is less than the Eb/Nt set point and the power control command instructs the BS transmitter to decrease its transmission power when the estimated Eb/Nt is greater than the Eb/Nt set point; and
an MS transmitter for receiving the power control command from the inner loop power control and transmitting the power control command to a BS comprising the BS transmitter.

25. The MS of claim 23, wherein the magnitude of the up step value is provided to the outer loop power control by a lookup table that assigns an up step value for each possible number of LTU errors of a frame of the received signal.

26. The MS of claim 23, wherein the set point is a energy-per-Walsh-code-to-total-noise-density (Ew/Nt) set point.

27. A wireless communication system, comprising:
a base station (BS); and
a mobile station (MB), the MS including a base station power control module that adjusts a power level of a signal transmitted by the BS using a measure of Link Transmission Unit (LTU) errors.

28. The system of claim 27, wherein the signal is divided into frames, each frame being further divided into at least two Link Transmission Units (LTUs), the MS further comprising
an receiver configured for receiving the signal from a transmitter in the BS, the receiver outputting a decoded signal of the received signal and a number of LTU errors in a frame of the received signal;
a Frame Error Rate (FER) estimator coupled to the MS receiver, the FER estimator estimating an FER of the decoded signal from the MS receiver and outputting the estimated FER of the decoded signal; and
an outer loop power control coupled to the FER estimator, the outer loop power control receiving the estimated FER from the FER estimator and the number of LTU errors from the MS receiver and a target FER, and adjusting and outputting a set point, wherein the outer loop power control increases the set point by an up step value when the estimated FER is greater than the target FER, the magnitude of the up set value depending upon the number of LTU errors, and decreases the set point by a down set value when the estimated FER is less than the target FER.

29. The system of claim 28, wherein the MS receiver outputs an estimated energy-per-bit-to-total-noise-density (Eb/Nt) of the received signal and the set point is an Eb/Nt set point, the MS further comprising
an inner loop power control for receiving the Eb/Nt set point from the outer loop power control and the estimated Eb/Nt from the MS receiver and outputting a power control command, wherein the power control command instructs the BS transmitter to increase its transmission power when the estimated Eb/Nt is less than the Eb/Nt set point and the power control command instructs the BS transmitter to decrease its transmission power when the estimated Eb/Nt is greater than the Eb/Nt set point; and
an MS transmitter for receiving the power control command from the inner loop power control and transmitting the power control command to a BS comprising the BS transmitter.

30. The system of claim 28, wherein the magnitude of the up step value is provided to the outer loop power control by a lookup table that assigns an up step value for each possible number of LTU errors of a frame of the received signal.

31. The system of claim 28, wherein the set point is a energy-per-Walsh-code-to-total-noise-density (Ew/Nt) set point.

32. The system of claim 28, wherein each LTU comprises an LTU Cyclic Read Check (CRC) field and the MS receiver estimates the number of LTU errors in a frame by checking the LTU CRC fields in the frame.

33. The system of claim 29, wherein the MS transmitter receives a pilot signal, multiplexes the received power control command with the received pilot signal, and outputs the multiplexed pilot signal to the BS comprising the BS transmitter.

34. The system of claim 27, wherein the signal is divided into frames, each frame being further divided into at least two Link Transmission Units (LTUs), the MS further comprising
an MS receiver receiving the signal from the BS transmitter and outputting a decoded signal of the received signal;
an LTU error rate estimator coupled to the receiver, the LTU error rate estimator estimating an LTU error rate of the decoded signal from the MS receiver and outputting the estimated LTU error rate of the decoded signal; and
an outer loop power control coupled to the receiver, the LTU error rate estimator receiving the estimated LTU error rate from the LTU error rate estimator and a target LTU error rate and adjusting and outputting a set point, wherein the outer loop power control increases the set point by an up step value when the estimated LTU error rate is greater than the target LTU error rate and the outer loop power control decreases the set point by a down set value when the estimated LTU error rate is less than the target LTU error rate.

35. The system of claim 34, wherein the MS receiver outputs an estimated energy-per-bit-to-total-noise-density (Eb/Nt) of the received signal and the set point is an Eb/Nt set point, the MS further comprising:
an inner loop power control for receiving the Eb/Nt set point from the outer loop power control and the estimated Eb/Nt from the MS receiver, and outputting a power control command, wherein the power control command instructs the BS transmitter to increase its transmission power when the estimated Eb/Nt is less than the Eb/Nt set point and the power control command instructs the BS transmitter to decrease its transmission power when the estimated Eb/Nt is greater than the Eb/Nt set point; and
an MS transmitter for receiving the power control command from the inner loop power control and transmitting the power control command to a BS comprising the BS transmitter.

36. The system of claim 34, wherein the magnitude of the up step value is provided to the outer loop power control by a lookup table that assigns an up step value for each possible number of LTU errors of a frame of the received signal.

37. The system of claim 34, wherein the set point is a energy-per-Walsh-code-to-total-noise-density (Ew/Nt) set point.
